(19) United States
(12) Patent Application Publication
(10) Pub. No.: US 2013/0073157 A1
(43) Pub. Date: Mar. 21, 2013

(54) ENHANCED TORQUE MODEL FOR VEHICLE HAVING A CVT

(71) Applicant: HB Performance Systems, Inc., Mequon, WI (US)

(72) Inventors: Kurt W. Person, Cedarburg, WI (US); Peter E. True, West Bend, WI (US); Michael E. Kenny, Cedarburg, WI (US); Andrew Doubek, Mequon, WI (US)

(73) Assignee: HB Performance Systems, Inc., Mequon, MI (US)

(21) Appl. No.: 13/622,817

(22) Filed: Sep. 19, 2012

Related U.S. Application Data
(60) Provisional application No. 61/536,383, filed on Sep. 19, 2011.

(51) Int. Cl. G06F 17/00; F16H 59/02

(52) U.S. Cl. 701/58; 180/54.1

(57) ABSTRACT

A vehicle (e.g., an ATV/UTV) comprising a body, at least two wheels supporting the body, a power source providing torque to at least one of the wheels, a torque control system for controlling the torque provided to the wheels. The torque control system has a plurality of slip modes, including a low-slip mode and a high-slip mode. A mode selector is provided for selecting one of the plurality of slip modes, and the torque control system defaults to the low-slip mode on vehicle start up. Preferably, the torque control system further includes a medium-slip mode. In another aspect, the vehicle has a continuously-variable transmission including a drive member and a driven member, and a torque control system for controlling the torque provided to the wheels. The torque control system is programmed to calculate an estimated primary torque factor and an estimated secondary torque factor for modifying as base engine torque.

### BACKGROUND

The present invention relates generally to off-road vehicles, such as All-Terrain Vehicles (ATVs) and Utility Vehicles (UTVs), and more specifically to torque-control systems for such vehicles.

Many modern vehicles include systems for controlling traction and stability. These systems often rely on the calculation of estimated wheel torque. For example, engine torque in many automotive applications can be calculated as follows:

Engine Torque=Tractive Forces at Tires/(Transmission Factor*Driveline Efficiency−Inertia Moment Driveline*Rotational Speed Change Rate Driveline]

Because the gear ratio and other inputs are generally known, these inputs are generally fixed and do not vary significantly with changing conditions. As a result, the vehicle's CPU can calculate an estimated wheel torque in order to assist control of traction and stability.

Some vehicles utilize continuously-variable transmissions (CVTs) for transferring power from the engine to the wheels. Some of these vehicles actuate the CVT hydraulically to achieve a desired engine operation under certain conditions. In these situations, the vehicle CPU knows the position of the hydraulic actuator, and thus knows the ratio of the transmission.

ATVs and UTVs commonly include CVTs with variable flyweight centrifugal clutches. In these vehicles, it is difficult to accurately calculate torque because the CPU does not know the gear ratio between the engine and the wheels. Therefore, in these vehicles, it is difficult to perform traction and stability control.

### SUMMARY OF THE INVENTION

The present invention provides a vehicle (e.g., an ATV/UTV) comprising a body, at least two wheels (e.g., four wheels) supporting the body, a power source (e.g., an engine) providing torque to at least one of the wheels, a torque control system for controlling the torque provided to the wheels. The torque control system has a plurality of slip modes, including a low-slip mode and a high-slip mode. A mode selector (e.g., selectable by a user) is provided for selecting one of the plurality of slip modes, and the torque control system defaults to the low-slip mode on vehicle start up. Preferably, the torque control system further includes a medium-slip mode.

In another aspect, the present invention provides a vehicle having a continuously-variable transmission including a drive member and a driven member, and a torque control system for controlling the torque provided to the wheels. The torque control system is programmed to calculate an estimated primary torque factor and an estimated secondary torque factor. In one embodiment, the drive member comprises a primary pulley, the driven member comprises a secondary pulley, and the continuously-variable transmission further includes a belt coupling the primary pulley and the secondary pulley. Preferably, the torque control system is programmed to calculate the estimated primary and secondary torque factors based on wheel speed and acceleration. The torque control system can also be programmed to calculate a base engine torque based on throttle position and engine speed. In this embodiment, the estimated primary torque factor and estimated secondary torque factor are used to modify the base engine torque calculation.

Other aspects of the invention will become apparent by consideration of the detailed description and accompanying drawings.

### BRIEF DESCRIPTION OF THE DRAWINGS

FIG. 1 is a perspective view of an ATV embodying the present invention.

FIG. 2 is a schematic of various components of the ATV in FIG. 1, including an engine, a CVT, and a wheel.

FIG. 3 is a schematic of a vehicle architecture for the ATV in FIG. 1.

FIG. 4 is a diagram of a basic control algorithm for the ATV in FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

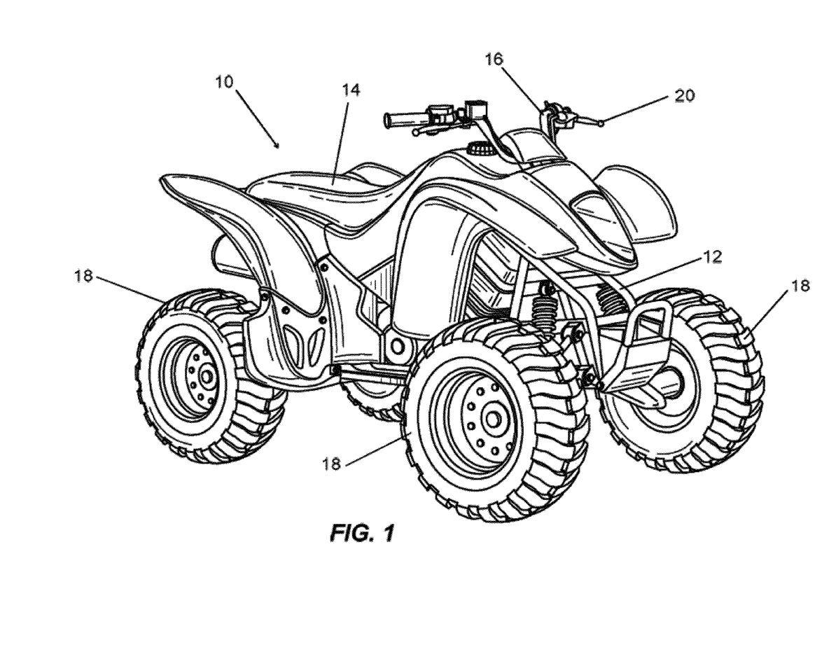

FIG. 1 illustrates an ATV 10 embodying the present invention. The ATV 10 includes a frame 12, a seat 14, handlebars 16, and four wheels 18, as is known in the art. Braking is actuated by brake levers 20 mounted on the handlebars 16. Throttle is actuated by a lever mounted to the handlebar 16. The illustrated ATV also has a CVT for transferring power from the engine to the wheels 18.

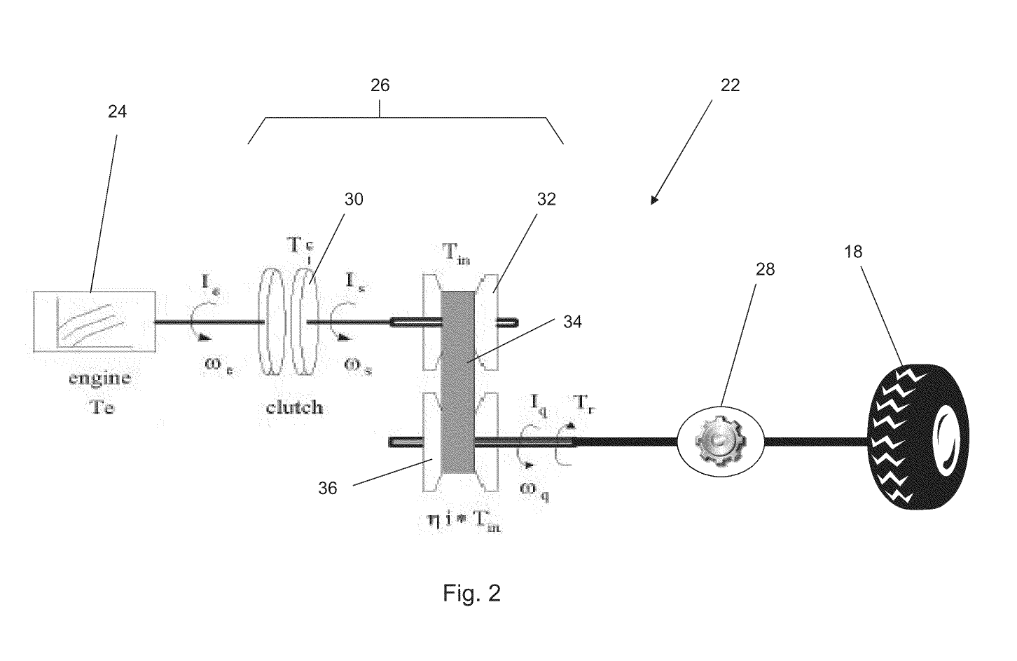

Referring to FIG. 2, the ATV 10 includes a powertrain 22 having an engine 24, a CVT 26, and a differential/transaxle 28. The illustrated CVT 26 includes a clutch 30, a primary pulley 32, a belt 34, and a secondary pulley 36. The clutch 30 is a centrifugal clutch (mechanically-variable, based on flyweight and rpm) that is incorporated into the primary pulley 32. The clutch 30 is design to change the ratio of the CVT 26 under changing operating conditions to equalize torque between the primary and secondary pulleys.

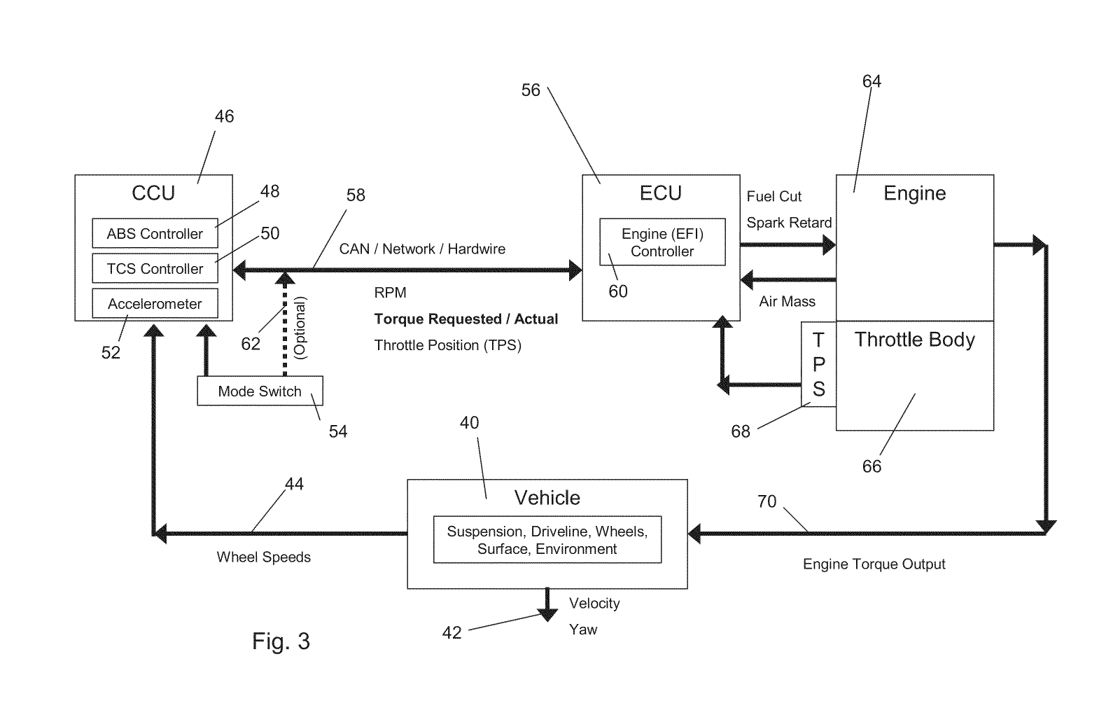

The illustrated ATV 10 includes a vehicle architecture that is represented in FIG. 3. The diagram includes the vehicle 40 (including suspension, driveline, wheels, surface and environment) that has a measurable velocity and a measurable yaw 42. Wheel speed information 44 is provided to a Chassis Control Unit (CCU) 46 that includes an anti-lock braking system (ABS) 48, a traction-control system (TCS) 50, and an accelerometer 52. A mode switch 54 allows the user to select one of multiple driving modes (e.g., multiple ABS modes and/or multiple TCS modes), as described below in more detail.

The CCU 46 is coupled to an engine control unit (ECU) 56 via an appropriate communication system 58, such as CAN or hardwire. The ECU 56 is equipped with EFI controller 60 for precise control of the engine. Information such as engine rpm, throttle position, and torque requested/actual can be communicated between the CCU 46 and ECU 56. Optionally, the input from the mode switch 54 can also be provided 62 to the ECU 56. The ECU 56 controls performance of the engine 64 and throttle body 66, which includes a throttle position sensor (TPS) 68. The engine 64 provides 70 engine torque to the vehicle 40.

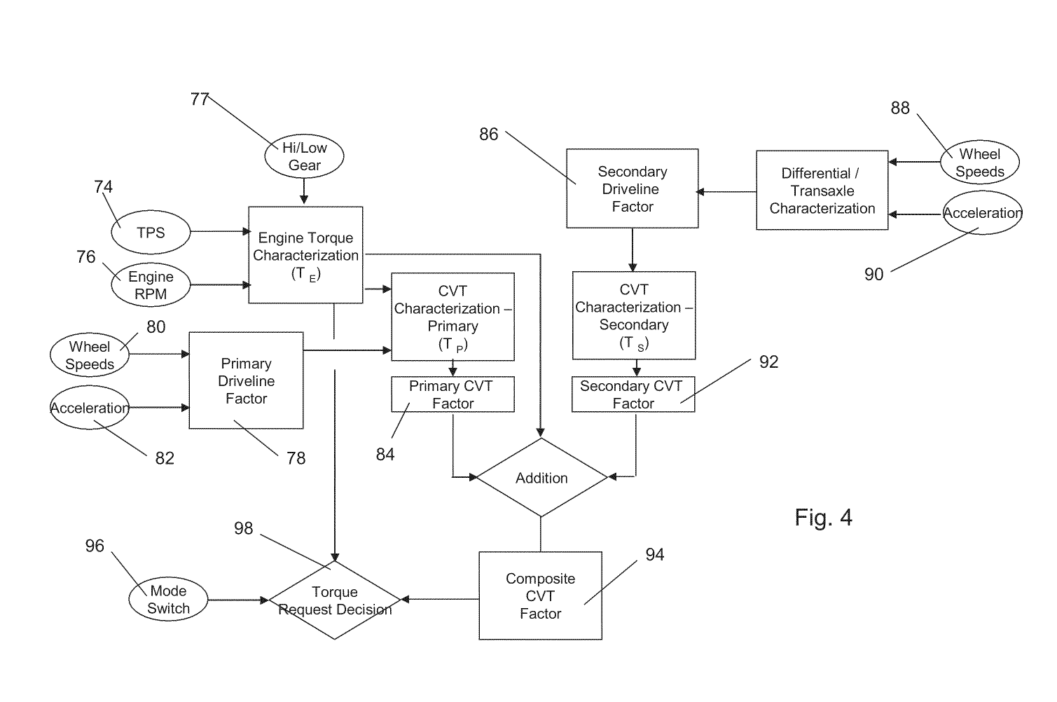

One aspect of the invention is to improve the calculated estimation of the torque requested/actual for CVT-equipped vehicles to improve vehicle handling characteristics via the TCS and ABS. In this regard, FIG. 4 illustrates a basic control algorithm for the improved torque estimation. The algorithm starts with an engine torque characterization T_{E} that is calculated in accordance with known formulas using input from the TPS 74, the engine RPM 76, and gear box position 77 (e.g., hi/low). T_{E} estimation is generally available from ECU and provides a general or base value of engine torque estimation. Typically the CCU will receive and interpret this information from the ECU. This T_{E} estimation satisfies ECU internal control needs and facilitates communication between ECU and CCU, however, alone this value is not precise or absolute in nature, and therefore limits the level of available torque control refinement.

The algorithm also calculates a primary torque characterization T_{P} and a secondary torque characterization T_{S}, which are used to modify the engine torque characterization T_{E}. The calculation of primary torque characterization T_{P} involves calculating a primary driveline factor 78 using wheel speed 80 and acceleration 82. The primary driveline factor 78 is derived from physical modeling of primary pulley characteristics through the sub-system or component (attributes may include mass, inertia, speed, geometry, friction coefficient, efficiency, etc.). Vehicle acceleration and wheel speeds are used to improve this model, where remaining attributes are generally fixed or defined by static physical properties. These signals are also used to bias the torque estimate with the influence of actual vehicle interaction and parameters versus engine-based parameters.

The primary driveline factor 78 is then used with T_{E} to arrive at the primary torque characterization T_{P}. Weighting factors are assigned in the calibration process related to accuracy and confidence in Primary Driveline Factor and T_{E} estimates for estimation of T_{P} which represent a complete torque model and estimation related to engine and driveline components upstream and through the primary pulley. The absolute value of T_{P} is converted to a mathematical gain or factor for input to a composite CVT factor which is ultimately used to modify the conventionally-based torque request decision.

The calculation of T_{S} involves calculating a secondary driveline factor 86 using wheel speed 88 and acceleration 90. The secondary driveline factor 86 is derived from physical modeling of driveline-based components including the differential or transaxle. Sub-system or component attributes may include ratio, mass, inertia, speed, geometry, friction coefficient, efficiency, etc. Vehicle acceleration and wheel speeds are used to improve this model, where remaining attributes are generally fixed or defined by static physical properties. These signals are also used to bias the partial-torque estimate with the influence of actual vehicle interaction in particular through the tire-road contact patch at the driven wheels.

The secondary driveline factor 86 is then used to arrive at a secondary torque characterization T_{S}. T_{S} (similar to T_{P}) can be derived from physical modeling of secondary pulley characteristics through sub-system or component (attributes may include mass, inertia, speed, geometry, friction coefficient, efficiency, etc.). The absolute value of T_{S} is converted to a mathematical gain or factor for input to a composite CVT factor which is ultimately used to modify the conventionally based torque request decision.

The primary CVT factor 84, secondary CVT factor 92, and engine torque characterization T_{E} are combined to arrive at a composite CVT factor 94. This can be the addition (or multiplication) of gain factors as per common control system practices. The composite CVT factor 94, engine torque characterization T_{E}, and mode switch input 96 are used to determine an appropriate torque request 98. More specifically, the CCU makes the request to the ECU with an adjustment, if needed, to T_{E} via an offset or multiplication factor (Composite CVT Factor) to enhance the precision of the torque request. This precision increase in turn enhances effectiveness of the user-selectable mode switch function on vehicle-level performance.

As noted above, the mode switch 54 allows the user to select one of multiple driving modes (e.g., multiple ABS modes and/or multiple TCS modes). The primary purpose of the mode switch is to allow the operator of the vehicle to select the levels of brake and traction control system interaction base on driver interaction and terrain conditions. In the illustrated embodiment, there are three different driving modes: Base Mode, Intermediate Mode, and Advanced Mode.

In base mode, brake and traction control system control parameter settings are programmed to recognize and intervene at low or shallow levels of slip generated by braking or accelerating. This is intended to provide high levels of vehicle control assistance. In intermediate mode, brake and traction control system control parameters are adjusted to recognize and intervene at levels of wheel slip which will require and increased level of operator interaction, contribution, and skill which can be intentionally selected by the operator. In advanced mode, brake control parameters are modified to deliver high brake deceleration on most off road surfaces. Traction control function is inhibited such that the operator has full control and range of engine torque via the throttle control. This intentional setting allows for enhanced operator interaction and control of the vehicle.

The mode switch 54 is designed so that the user can easily change the mode of the torque-control system. For example, the mode switch 54 can be a push-button switch that digitally toggles between the three modes with a visual representation of the currently-active mode. In one preferred embodiment, the vehicle is programmed so that the torque-control system defaults to the base mode every time the vehicle is restarted. More specifically, at each ignition on/start cycle, the brake and traction control system will default to the base mode settings regardless of the mode switch position. Mode switch “logic” as recognized by the control system software will require the operator to move the mode switch to base mode prior to selecting intermediate or advanced mode. As such, the mode switch will provide operator command messages or requests. These command messages can be provided either via CAN or by specific continuity or ohm values.

Various features and advantages of the invention are set forth in the following claims.

1. A vehicle comprising:
a body;
at least two wheels supporting the body;
a power source providing torque to at least one of the wheels;
a torque control system for controlling the torque provided to the wheels, the torque control system having a plurality of slip modes, including a low-slip mode and a high-slip mode; and
a mode selector for selecting one of the plurality of slip modes, wherein the torque control system defaults to the low-slip mode on vehicle start up.

2. A vehicle as claimed in claim 1, wherein the vehicle comprises an ATV or UTV.

3. A vehicle as claimed in claim 1, wherein the at least two wheels comprises four wheels.

4. A vehicle as claimed in claim 3, wherein the power source provides torque to at least two of the wheels.

5. A vehicle as claimed in claim 1, wherein the power source comprises an engine.

6. A vehicle as claimed in claim 1, wherein the torque control system further has a medium-slip mode.

7. A vehicle as claimed in claim 1, wherein the mode selector is selectable by a user of the vehicle.

8. A vehicle comprising:
a body;
at least two wheels supporting the body;
a power source providing torque to at least one of the wheels;
a continuously-variable transmission including a drive member and a driven member;
a torque control system for controlling the torque provided to the wheels, wherein the torque control system is programmed to calculate an estimated primary torque factor and an estimated secondary torque factor.

9. A vehicle as claimed in claim 8, wherein the vehicle comprises four wheels.

10. A vehicle as claimed in claim 8, wherein the power source comprises an engine.

11. A vehicle as claimed in claim 8, wherein the drive member comprises a primary pulley and the driven member comprises a secondary pulley, and wherein the continuously-variable transmission further includes a belt coupling the primary pulley and the secondary pulley.

12. A vehicle as claimed in claim 8, wherein the torque control system is programmed to calculate the estimated primary torque factor based on wheel speed and acceleration.

13. A vehicle as claimed in claim 8, wherein the torque control system is programmed to calculate the estimated secondary torque factor based on wheel speed and acceleration.

14. A vehicle as claimed in claim 8, wherein the torque control system is programmed to calculate a base engine torque based on throttle position and engine speed, wherein the estimated primary torque factor and estimated secondary torque factor are used to modify the base engine torque calculation.

15. A method of controlling vehicle engine torque comprising:
calculating a base engine torque;
determining a primary torque factor;
determining a secondary torque;
comparing the primary torque factor to the secondary torque factor to determine a transmission factor; and
modify the base engine torque using the transmission factor.

16. The method of claim 15, wherein calculating the base engine torque utilizes inputs of throttle position and engine RPM.

17. The method of claim 15, wherein estimating a primary torque factor utilizes wheel speed and acceleration.

18. The method of claim 15, wherein estimating a secondary torque factor utilizes wheel speed and acceleration.
